(19) United States
(12) Patent Application Publication
(10) Pub. No.: US 2007/0189826 A1
(43) Pub. Date: Aug. 16, 2007

(54) Printing apparatus and control program for a printing apparatus recorded in computer-readable recording medium

(75) Inventors: Keiko Tsubota, Kariya-shi (JP); Hidekazu Ishii, Aisai-shi (JP); Tomoki Miyashita, Nagoya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 11/705,634

(22) Filed: Feb. 13, 2007

(30) Foreign Application Priority Data
Feb. 14, 2006 (JP) 2006-036096

(51) Int. Cl. B41J 5/30

(52) U.S. Cl. 400/62

(57) ABSTRACT

This disclosure provides a printing apparatus which enables a user to adjust easily and appropriately a direction of an image that is to be printed onto a recording object medium. When a user gives instructions for the execution of option printing, a personal computer displays on its monitor an option printing screen 100. The option printing screen 100 indicates print patterns 103a-103d representing states in which an “ABC” character string which constitutes an object image for printing is rotated in each of upward, downward, rightward and leftward directions. If a user selects any one of the print patterns 103a-103d, print data is produced based on an image hat has been rotated corresponding to the pattern. A tape printing apparatus prints onto a tape an image that has been rotated based on print data created by the personal computer and, by cutting a tape that has been discharged onto a tray, produces a label.

This application claims priority from JP 2006-036096, filed Feb. 14, 2006, the entire disclosure of which is incorporated herein by reference thereto.

### BACKGROUND

1. Field of the Invention

The disclosure relates to a printing apparatus for printing onto a printing object medium an image based on print data.

2. Description of the Related Art

Conventionally, a tape print apparatus has been known that is capable of printing an arbitrary image and character string onto a print tape in which an adhesive printing object sheet whose rear side has been coated in advance with an adhesive agent and a separable sheet are overlaid in such a way that they are separable from each other. In such a tape print apparatus, after for example, a subject matter or a title name has been printed onto the surface of the printing object sheet, a print tape that is discharged from a label discharge port is cut out to a predetermined length so as to produce a label. By separating the printing object sheet of the label from the separable sheet, a user can then affix this label onto an object such as a rear cover sheet of a document file or a rear side of a video tape.

In producing the label from the tape printing apparatus, printed labels are discharged from the label discharge port with the directions of images printed onto the surface of the printing object sheet in a uniform manner. Therefore, if, for example, a user wants to affix a label onto any object with a printed image facing in a different direction, the user has had to adjust the direction in which the label is affixed onto the object by turning the label in a different direction before affixing it.

As a technique for adjusting the direction of a character printed on the label, a printing apparatus is known that is disclosed in Japanese Patent Application Laid-Open No.2000-185447. When instructions have been given for the printing of a character string input through the keyboard, is instructed, the same printing apparatus prints the character string onto a label by making an appropriate adjustment to an arrangement sequence of the character string, or by rotating the direction of the character string so that the character string can be recognized in its normal standing state when the label is affixed onto an object in a posture conforming to a direction stipulated by a user in instructions that are entered. This printing apparatus can print the character string easily, and it is thus easy to recognize on the basis of the posture in which it is affixed onto the object in question.

### SUMMARY

However, adjustment of the direction of a label affixed onto an object by a user each time in a conventional printing apparatus imposes a burdensome task on the user, and leads to reduction in the level of efficiency of label-affixing work. Particularly when plural labels of the same type are printed (for example, product labels on which an identification number is automatically printed), and the same labels are affixed onto objects of the same type (for example, plural identical products), a user has on each occasion to adjust direction in which each label is affixed, even when the directions of the respective labels that are to be affixed onto the objects are identical. When a large number of labels are affixed onto an object, increases in the burden on a user and reduction in the level of efficiency of affixing work are considerable. For this reason, demands have been made for labels to be easily and rapidly affixed onto objects in an affixing direction that is favored by a user, by affixing them to objects in a posture in which the labels have been discharged from a label discharge port of the tape printing apparatus without any adjusting the direction of the labels discharged.

Although, according to the printing apparatus described in the Japanese Patent Application Laid-Open No.2000-185447, the direction of characters printed on a label can be adjusted, when the label is affixed onto an object the character string is printed so as to be in a normal standing state. Thus, this printing apparatus cannot adjust the direction of the entire image (that is, an entire label) containing the characters, thereby making it impossible to solve the problem whereby a user has to adjust the affixing direction of the label. Further, because this printing apparatus does not enable a user to recognize a printed condition (direction of an image or the like) unless the user actually prints an image or characters on the label. A direction of an image expected by a user does not on occasions necessarily match a direction of an image that is actually printed onto the label, and this situation has proved burdensome.

The disclosure has been achieved to solve the problem described above and an object of the disclosure is to provide a printing apparatus which enables a user to adjust easily and appropriately the direction of an image to be printed on a recording medium. Further, another object of the disclosure is to provide a printing apparatus which enables the label produced to be affixed easily and rapidly onto an object in an affixing direction that is favored by a user, without any necessity for adjusting the affixing direction of the label on each occasion.

To achieve the above-mentioned object, according to a first aspect of the disclosure, a printing apparatus is provided comprising: a printing device that prints onto a recording object medium an image based on print data; an image direction-setting device that arbitrarily sets a direction of the image relative to the recording object medium; an image-rotating device that rotates the image; and a print control device that enables the printing device to print the image rotated by the image-rotating device so as to conform to the direction of the image set by the image direction-setting device.

According to a second aspect of the disclosure, a printing apparatus is provided comprising: a printing device that prints onto a recording object medium an image based on print data; and a control device that arbitrarily sets a direction of the image relative to the recording object medium, rotates the image and enables the printing device to print the rotated image so as to conform to the direction of the image that has been set.

According to a third aspect of the disclosure, there is provided a control program of printing apparatus recorded on a computer-readable recording medium, comprising: an image direction-setting step of setting arbitrarily a direction of an image relative to a recording object medium; an image-rotating step of rotating the image; and a print control step of printing the image rotated in the image-rotating step so as to conform to the direction of the image set in the image direction-setting step.

### BRIEF DESCRIPTION OF THE DRAWINGS

Exemplary embodiments of the disclosure will be described in detail below with reference to the accompanying drawings in which:

FIG. 1 is a perspective view of schematic outline of a personal computer and a tape printing apparatus connected thereto according to a first embodiment;

FIG. 2 is a block diagram showing an electrical structure of a personal computer;

FIG. 3 is a main flowchart showing an option printing processing;

FIG. 4 is a flowchart showing details of an option printing screen display processing;

FIG. 5 is a flowchart showing details of a preview image creation processing;

FIG. 6 is a diagram showing a specific example of the option printing screen;

FIG. 7 is a flowchart showing main processing of the tape printing apparatus;

FIG. 8 is a plane view of a schematic outline of a label printer according to a second embodiment;

FIG. 9 is a block diagram showing the electrical configuration of the label printer;

FIG. 10 is a flowchart showing the main processing of the label printer; and

FIG. 11 is a flowchart showing details of the option printing processing.

### DETAILED DESCRIPTION OF EXEMPLARY EMBODIMENTS

Hereinafter, the first embodiment of the disclosure will be described with reference to the accompanying drawings. As the “printing apparatus” of the disclosure, a stand-alone type tape printing apparatus 1 and a personal computer 2, which are connected to each other, will be described.

First, the tape printing apparatus 1 and the personal computer 2 will be described.

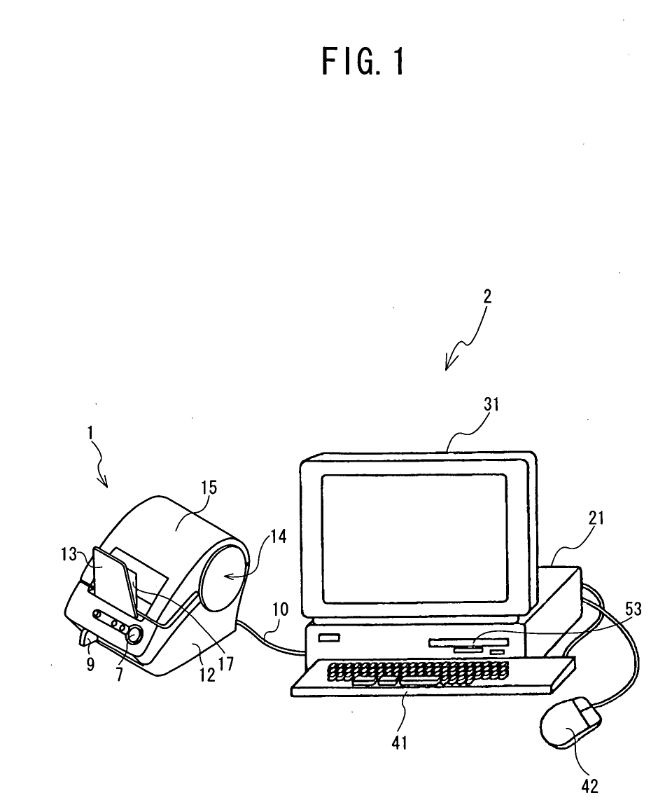

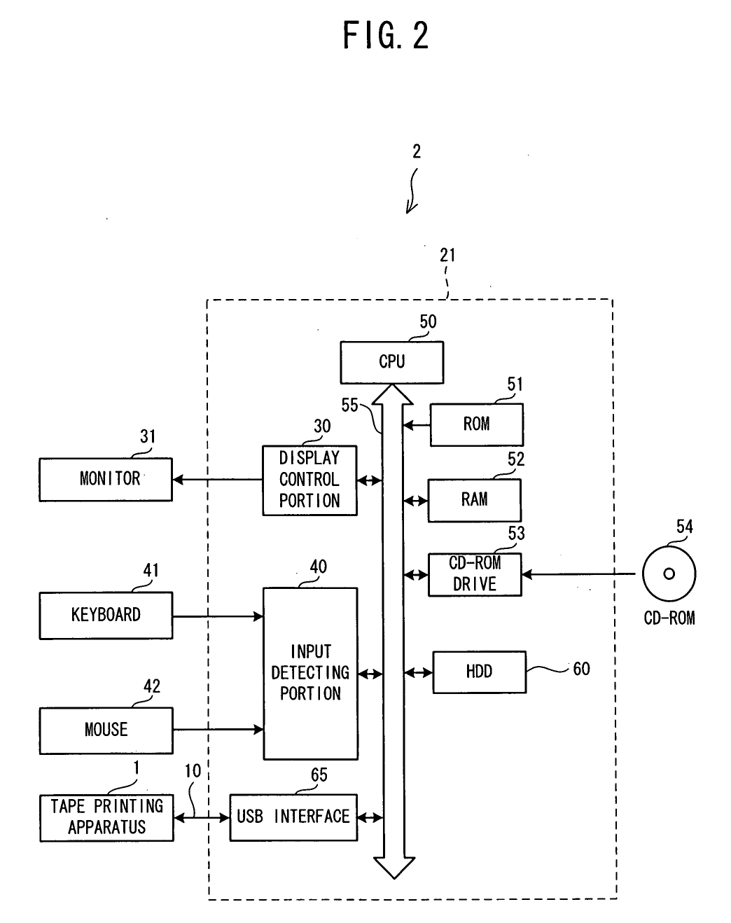

As shown in FIG. 1, the tape printing apparatus 1 and the personal computer 2 are connected through an USB cable 10 based on, for example, the USB standard in such a way that they can exchange data through the USB cable 10. The personal computer 2 is a well known personal computer and, as shown in FIG. 1, comprises a main body 21 including a CPU 50 and the like (see FIG. 2), a monitor 31, a keyboard 41 and a mouse 42. The monitor 31, the keyboard 41 and the mouse 42 are respectively connected to the main body 21 by means of a connection cable. The personal computer 2 creates print data which are based on image data that have been produced by document creation application, or by image-editing application, and sends that print data to the tape printing apparatus 1.

The tape printing apparatus 1 comprises a main body case 12, an upper cover 15, a tray 13, a power button 7, a cut lever 9 and the like. The main body case 12 and the upper cover 15 are made of transparent resin and the upper cover 15 is installed onto a top end portion of the rear side of the main body case 12 in such a way that it is capable of opening and closing freely so as to cover an upper side of a roll tape holder-accommodating portion 14 that accommodates a roll tape holder (not shown) around which a long tape 17 is wound. The tray 13 is made of transparent resin and erected in such a way that it is substantially opposite to a center portion of the front side of the upper cover 15. The power button 7 is disposed in front of the tray 13. The cut lever 9 is provided on a front side face of the main body case 12 in such a way that it is capable of moving in a right and left direction so as to move a cutter unit (not shown). An USB interface (not shown) is provided on a rear face of the main body case 12, and a power cord (not shown) is connected to the rear face of the main body case 12, and to the personal computer 2 through the USB cable 10.

The tape printing apparatus 1 includes a printing mechanism (not shown) which prints on a tape 17 by running the tape 17 between a thermal head that has a plurality of heat-generating devices and a platen roller that is in contact with the thermal head. The tape 17 wound around the mounted roll tape holder is printed onto this printing mechanism and discharged onto the tray 13. A user then operates the cut lever 9 so as to cut the tape 17 that has been discharged onto the tray 13 with a cutter unit (not shown), so that a label is thereby created.

Next, the electrical structure of the personal computer 2 will be described. As shown in FIG. 2, the personal computer 2 has a CPU 50 for controlling the personal computer 2. A ROM 51, a RAM 52, a CD-ROM drive 53 and an HDD 60 are connected to this CPU 50 through a bus 55. The ROM 51 stores programs such as a basic input and output system (BIOS) which the CPU 50 executes. The RAM 52 stores data temporarily. With a CD-ROM 54 inserted into the CD-ROM drive 53 as a memory medium for program and data the CD-ROM device 53 reads data. The HDD 60 is a memory device for data. The HDD 60 contains a program memory area, a program-related information memory area, an image data memory area and the like. The program memory area stores a variety of programs that are executed by the personal computer 2, including a print control program which will be described later. The program related information memory area stores information such as setting, initial values and data that are all necessary for execution of programs. The image data memory area stores image data which is to be the object of printing.

Further, an USB interface 65, a display control portion 30, the key board 41, the mouse 42 and an input detecting portion 40, which detects inputs, are connected to the CPU 50 through the bus 55. The USB interface 65 communicates with an external unit that includes the tape printing apparatus 1, the display control portion 30 executes screen display processing of the monitor 31 so as to display a control screen for a user, and the keyboard 41 and the mouse 42 are used to enable a user to input an operation. Furthermore, the personal computer 2 may be provided with a flexible disk drive, an MO drive, an audio input or output portion, and a variety of interfaces (not shown)

When a variety of programs or the like are introduced, they are read from the CD-ROM 54, which stores a printer driver in which a print control program has been built, and settings and data for use in executing this program and the like, into various memory areas provided in the HDD 60. Furthermore, the method of acquiring the print control program (printer driver) of the personal computer 2 and its applicable data need not be limited to by means of the CD-ROM 54. Rather, acquisition is also possible through other recording mediums such as a flexible disk or an MO. Further, such data may also be acquired from other terminals on a network, by connecting the personal computer 2 to that network.

Next, an explanation will be given of an option printing processing which is executed by the personal computer 2 and according to which printing is performed by means of adjustment of a direction of an image so as to conform to instructions from a user.

When a user gives instructions for “ordinary printing” by creating image data using document creation application or image-editing application, the printer driver in the personal computer 2 is started. Then, print data is created from image data based on the print control program contained in the printer driver. Then, the print data is sent to the tape printing apparatus 1 and the tape printing apparatus 1 executes tape printing based on the print data.

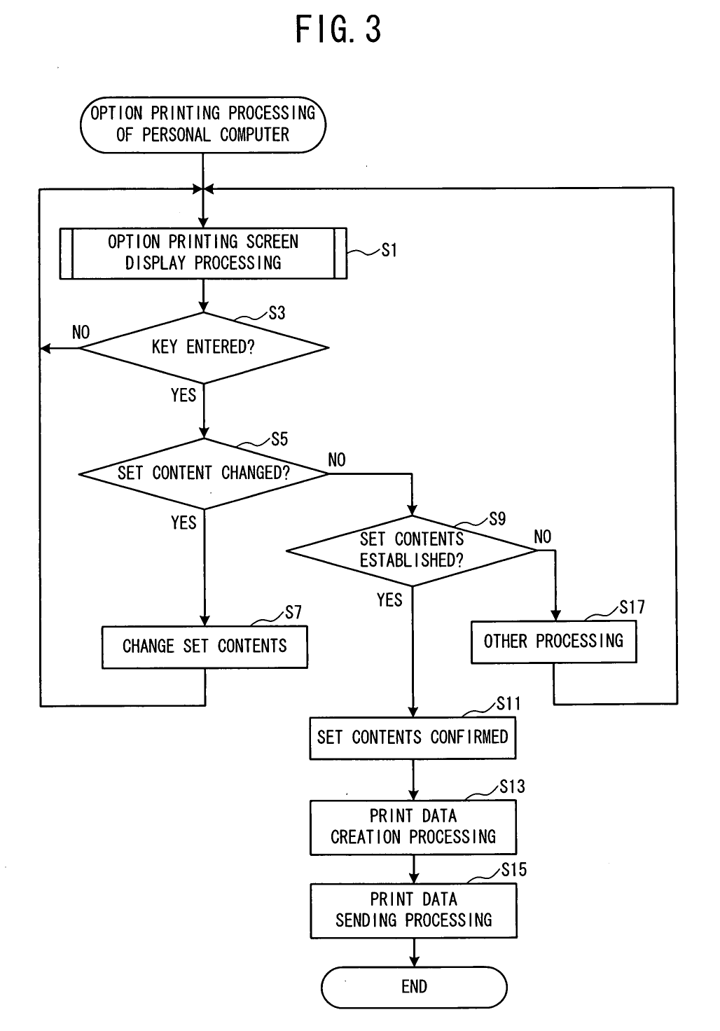

On the other hand, according to this embodiment, when a user produces image data by use of the document creation application or by use of image-editing application, and gives instructions for “option printing”, the printer driver is started up. Then, the option printing processing (FIG. 3) is executed by the CPU 50 based on the print control program contained in the printer driver. Hereinafter, an explanation will be given, as an “ABC” character string, of an image (object image for printing) based on image data for which a user has given instructions for printing.

In the option printing processing shown in FIG. 3, when instructions are given for “option printing”, an option printing screen display processing (S1) is executed for displaying a dialog (hereinafter referred to as an option printing screen 100) which urges a user to execute various settings relating to the option printing.

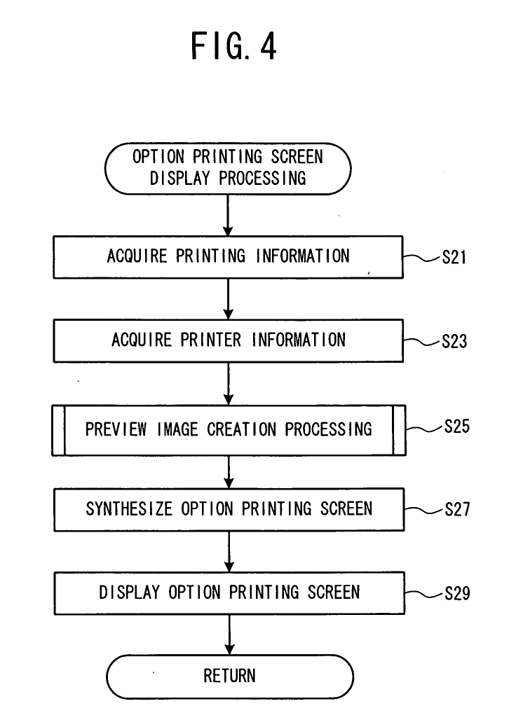

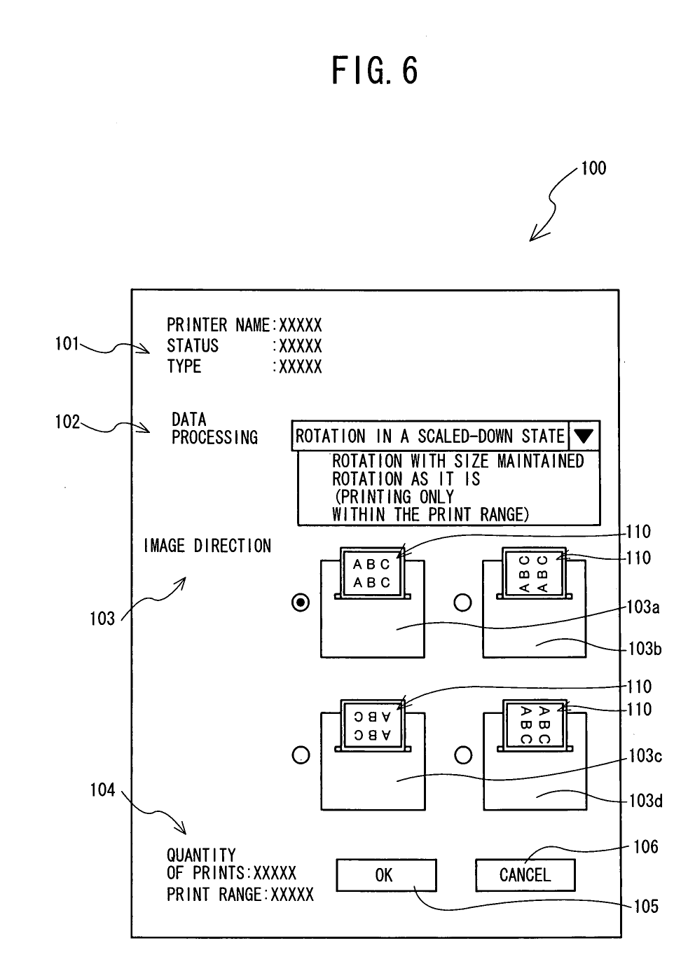

In the option printing screen display processing (S1) as shown in FIG. 4, a variety of data (printing information) relating to printing contents that have been set by a user are first acquired (S21). In this context, it may be assumed that the quantity of prints and the range for printing set by the user are acquired as “printing information”. Next, a variety of data (printer information) relating to the tape printing apparatus 1 is acquired through communication with the tape printing apparatus 1 (S23). In this context, it can be assumed that factors such as a printer name, a status, the type of tape printing apparatus 1 and a label width 110 (see FIG. 6) set on the tape 17 are acquired as “printer information”. Further a preview image creation processing for creating a preview image is executed by rotating the object image for printing at plural angles that have been set in advance (S25).

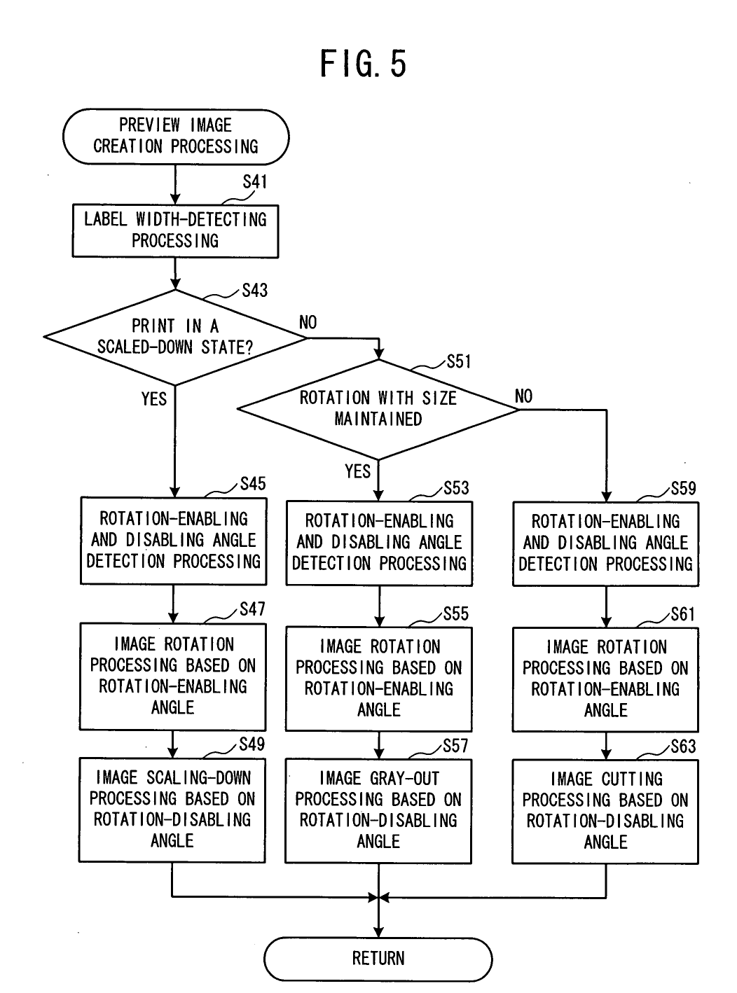

As shown in FIG. 5, a label width-detecting processing for detecting a width of a label set on the tape 17 (S41), which serves as a recording medium, is executed during the course of the preview image creation processing (S25). In this label width-detecting processing, the label width 110 can be detected from printer information acquired in S23 from the tape printing apparatus 1.

Next, a determination is made as to whether or not the data processing that has been set is “print in a scaled-down state” (S43). This data processing is executed when the object image for printing extends beyond a feasible range for printing the label, and a user can select any one of “rotation in a scaled-down state”, “rotation with size maintained” and “rotation as it is (printing only within the print range) from the option printing screen 100 (FIG. 6), which will be described later. Furthermore, it may be assumed that in a default state in which no data processing has been selected by a user, data processing “rotation in a scaled-down state” is being set in advance.

If the data processing is “print in a scaled-down state” (S43: YES), rotation-enabling and disabling angle detection processing is executed for detecting an angle which enables or disables rotation of an object image for printing (S45). In this embodiment, the object image for printing is rotated by at rotational angles (0°, 90°, 180°, and 270°) set in advance by means of the print control program. However, when the object image for printing is rotated, a rotated image that is printed may sometimes extend beyond the feasible range for printing (the label width 110 detected in S41). Thus, in S45, when the object image for printing has been rotated, an angle in which the image is being rotated does not exceed the label width 110 (rotation-enabling angle) and an angle in which the rotated image exceeds the label width 110 (rotation-disabling angle) can be detected.

In this embodiment, even when, for example, the object image for printing is rotated for 0° (no rotation) or for 180°, and a rotated image indicating an “ABC” character string is printed on the tape 17, the printed image does not exceed the label width 110. However, when the printing object is rotated for 90°, or for 270°, the image that is rotated, and that indicates the “ABC” character string, is elongated vertically. Thus, when such an image is printed onto the tape 17, the image that is printed may on occasions exceed the label width 110. In other words, 0° (no rotation) and 180° are detected as rotation-enabling angles and 90° and 270° are detected as rotation-disabling angles.

On the basis of the rotation-enabling angle detected in S45, an image rotation processing (S47) is performed so as to rotate the object image for printing. In other words, an “ABC” character string that represent an object image for printing is subjected to rotation at 0° and at 180° respectively. Thus, with an image at 0° the “ABC” character string remains in its existing state (an upward facing state), and in the case of an image rotated at 180° the “ABC” character string assumes a downward facing state.

Further, an image rotation processing is executed for rotating an object image for printing based on the rotation-disabling angle detected in S45, and for then performing a processing for scaling down the rotated image (S49) In other words, an “ABC” character string which represents an object image for printing is rotated respectively for 90° and for 270°. Moreover, in an image rotated for 90°, the “ABC” character string assumes a leftward direction and in an image rotated for 270°, the “ABC” character string assumes a rightward direction. Further, the rotated image of the “ABC” character string is in its entirely scaled-down uniformly and can thus be accommodated within the label width 110.

The four character strings “ABC” that were directed in upward, downward, rightward and leftward directions in S47 and S49 are stored in a predetermined memory area of the RAM 52. Further, in this embodiment, in the tape printing apparatus 1 the direction in which the tape 17 is discharged (that is, an upward direction) is an upward direction on an object image for printing before rotation. In other words, the upward, downward, rightward and leftward directions of the object image for printing are determined on the basis of the direction in which the tape 17 is discharged.

On the other hand, if data processing is “rotation with size maintained” (S43: NO, S51: YES), the rotation-enabling and disabling angle detection processing (S53), and the image rotation processing (S55) based on the rotation-enabling angle detected in S53, are executed in the same way as described above. Moreover, image gray-out processing based on the rotation-disabling angle detected in S53 is executed (S57). In S57, the gray-out processing is executed for rotating the object image for printing based on the rotation-disabling angle, and for further synthesizing the rotated image, as a gray-out image, which indicates that a user cannot select it. In this context, rotated images of an “ABC” character string rotated for 90° and 270° are synthesized as gray-out images, and stored in a predetermined memory area of the RAM 52.

If the data processing is “rotation as it is (printing only within the print range)(S51: NO), the rotation-enabling and disabling angle-detecting processing (S59), and the image rotation processing (S61) based on the rotation-enabling angle detected in S59, are executed in the same way as described before. Moreover, image-cutting processing based on the rotation-disabling angle detected in S59 is executed (S63). In S63, cutting processing is executed for rotating the object image for printing based on the rotation-disabling angle, and for further cutting out the rotated image so that only the portion that falls within the label width of the rotated image is displayed. In this context, only the portion that falls within the label width 110 of a rotated image of the “ABC” character string rotated for 90° and for 270° is cut out and stored in a predetermined memory area of the RAM 52.

Each of the rotated images that have been stored by means of the processing described above in the predetermined memory area of the RAM52 is used so as to form plural preview images represented on a virtual label, to be described later, on the option printing screen 100 (FIG. 6), also to be described later. In more detailed terms, an image that has not been rotated (rotated for 0°) from among the object images for printing, and that indicates the “ABC” character string is a preview image facing upwards, an image rotated for 90° is a preview image facing leftwards, an image rotated for 180° is a preview image facing downwards and an image rotated for 270° is a preview image facing rightwards. Furthermore, after S49, S57 and S63 have been executed, the processing returns to the option printing screen display processing (FIG. 4).

The processing returns to FIG. 4, in which the option printing screen is synthesized based on various items of information acquired or created in S21, S23 and S25 (S27). In other words, the option printing screen (FIG. 6) is synthesized based on printing information acquired in S21, printer information acquired in S23 and the preview image created in S25. Moreover, this option printing screen is displayed on the monitor 31 (S29) and the processing returns to the option printing processing (FIG. 3).

As shown in FIG. 6, the option printing screen 100 is comprised of a printer information display portion 101, a data processing-selecting portion 102, an image direction-selecting portion 103, a printing information display portion 104, an OK button 105 and a cancel button 106. The printer information display portion 101 displays information about the tape printing apparatus 1. The data processing-selecting portion 102 is a menu for selecting data processing to be executed when the object image for printing extends beyond the feasible range for printing on a label. The image direction-selecting portion 103 is a menu for selecting the direction of an image to be printed on the label. The printing information display portion 104 indicates a print content set by a user. The OK button 105 establishes a content set on the option printing screen 100. The cancel button 106 cancels the content that has been set on the option printing screen 100. Moreover, printer information acquired in S23 is displayed on the printer information display portion 101 and printing information acquired in S21 is displayed on the printing information display portion 104.

Further, on the image direction-selecting portion 103 plural preview images that were created in S25 are displayed. More specifically, in print patterns 103a, 103b, 103c, 103d respectively a state is represented in which a virtual label is discharged from a virtual printer that represents the tape printing apparatus 1. The virtual labels of the print patterns 103a-103d indicate images rotated in upward, leftward, downward and rightward directions as an object image for printing. Thus, a user can select a desired image direction after confirming a print condition based on the respective print patterns 103a-103d on the option printing screen 100 before actually printing the “ABC” character string within the label width 110 set on the tape 17.

Furthermore, the data processing-selecting portion 102 can select any one of three data processings, “rotation in a scaled-down state”, “rotation with size maintained” and “rotation as it is (printing only within the printing range)”. If the object image for printing exceeds the label width, data processing is executed that has been selected by the data processing-selecting portion 102 described above (see FIG. 5). Further, the option printing screen 100 shown in FIG. 6 indicates an example of screen when data processing “rotation in a scaled-down state” has been selected. Because, in this embodiment, when an object image for printing is rotated for 90° and 270°, the printed image exceeds the label width 110, on the print patterns 103b and 103d each rotated image is displayed in a scaled-down state (see S43: YES, S45, S47, S49 in FIG. 5).

The processing now returns to FIG. 3, in which, after the option printing screen 100 has been displayed, the apparatus stands by for a key input through the keyboard 41, or through the mouse 42 (S3). When an input is made through the keyboard 41 or the like (S3: YES), if that input causes a change in the content set on the option printing screen 100 (S5: YES), the content that has been set on the option printing screen 100 is changed in accordance with the input (S7). Further, the processing then returns to S1, in which the option printing screen 100 is updated in accordance with the change in the contents set in S7.

If, for example, the data processing set by the data processing-selecting portion 102 is changed to “rotation with size maintained”, a user cannot select the print patterns 103b, 103d from the image direction-selecting portion 103 because the print patterns 103b, 103d are displayed in gray (see S51 in FIG. 5: YES, S53, S55, S57). Further, if the data processing set by the data processing-selecting portion 102 is changed to “rotation as it is (printing only within the printing range), only a portion that falls within the label width 110 of each rotated image is displayed on the print patterns 103b, 103d (see S51: NO, S59, S61, S63 in FIG. 5).

If, on the other hand, an input through the keyboard 41 or the like confirms the contents set on the option printing screen 100 (S5: NO, S9: YES), the contents set on the option printing screen 100 are confirmed (S11) and a print data creation processing is executed for creating print data based on the image data (S13). In this embodiment, when a user selects the OK button 105 on the option printing screen 100, it is determined that the contents set on the option printing screen 100 have been confirmed.

In this print data creation processing (S13), print data for use in printing in the tape printing apparatus 1 is created based on a rotated image selected from among rotated images respectively stored in the predetermined memory area of the RAM 52 by the image direction-selecting portion 103, and that correspond to print patterns 103a-103d. More specifically, if the print pattern 103a is selected, print data is created based on an image rotated for 0°. Likewise, if any of the print patterns 103b-103d is selected, print data is created based on the rotated image in question for 90°, for 180°, or for 270°.

If a rotated image which is an object for printing exceeds the label width 110, print data is created corresponds to data processing selected by the data processing-selecting portion 102. More specifically, if a data processing “rotation in a scaled-down state” is selected, the print data is created based on a rotated image that has been scaled down so as to correspond with the label width 110. If a data processing “rotation with size maintained” is selected, the print data can be created based on only rotated images corresponding to the print patterns 103a and 103c. Further, if data processing “rotation as it is (printing only within the printing range) is selected, print data is created based on only the portion that falls within the label width 110 of the rotated image.

Finally, a print data sending processing is executed for sending the print data to the tape printing apparatus 1 (S15) and the option printing processing is thereby terminated. Further, even if an input from the keyboard 41 or the like does not change the contents set on the option printing screen 100 nor establishes the content (S5: NO, S9: NO), another type of processing that corresponds with that input is executed. For example, if a user selects the cancel button 106 on the option printing screen 100 (not shown), the option printing processing is terminated without any subsequent processing being performed. After S7 or S17 has been terminated, unless the option printing processing is terminated, the processing returns to S1 in which the apparatus stands by for an input by a user.

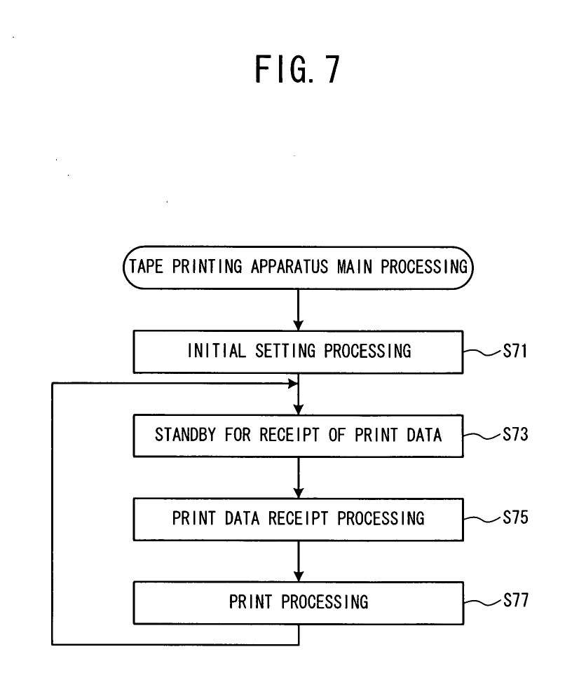

Next, main processing that is executed by the tape printing apparatus 1 will be described. Furthermore, when the tape printing apparatus 1 is powered on this main processing (FIG. 7) is executed by the CPU (not shown) based on the control program that has been stored in the ROM (not shown).

In the main processing of the tape printing apparatus 1, as shown in FIG. 7, an initial setting processing such as data initialization or flag reset is initially executed (S71), and the apparatus stands by for receiving print data from the personal computer 2 (S73). If print data is sent from the personal computer 2 during this standby period for receipt of the print data, that print data is received and then a print data reception processing is executed for storing the print data in a print buffer of the RAM (not shown) (S75). A print processing is then executed for printing on the tape 17 an object image for printing based on the print data received in S75 so as to produce a label (S77).

More specifically, printing of the “ABC” character string and tape feed control are executed synchronously based on the print data stored in the print buffer so that the “ABC” character string is printed within the label width 110 set on the tape 17, in a direction of the image that has been set by a user. Finally, when a user operates the cut lever 9 so as to cut the tape 17 that has been discharged onto the tray 13, a label is produced.

An “ABC” character string is thus printed onto a label produced in this manner, in a direction of the image that has been set by a user. Thus, if, for example, a user wants to affix the label onto an object with the “ABC” character string facing a leftward direction, by selecting the print pattern 103b in which the image faces leftwards from the option printing screen 100, an “ABC” character string is printed in such a way that it faces leftwards, as has been indicated by the preview image. Thus, if a label discharged onto the tray 13 from the label discharge port of the tape printing apparatus 1 is affixed as it is, the “ABC” character string that is printed onto the label of an object is indicated in such a way that, even if the affixing direction has not been adjusted by rotating the label along a circumferential direction, it still faces leftwards, in the same manner as has been indicated in the print pattern 103b.

In the tape printing apparatus 1 and personal computer 2 of the first embodiment, the personal computer 2 displays on the monitor 31 an option printing screen 100 on which are displayed print patterns 103a-103d, each of which indicates a state in which the object image for printing (an “ABC” character string) is rotated in one of a plurality of directions and print data is thus created based on a rotated image that corresponds to the one of print patterns 103a-103d that has been selected. On the other hand, the tape printing apparatus 1 prints a rotated image within the label width 110 that has been set on the tape 17 based on the print data created by the personal computer 2 and cuts the tape 17 that has been discharged onto the tray 13 so as to produce a label.

Thus, the direction of the “ABC” character string that is printed on the tape 17 can be adjusted by a user simply and appropriately. Moreover, a user does not need to adjust the affixing direction of the label on each occasion and can affix the label on an object easily and rapidly in a desired affixing direction. Further, because a user can select from the option printing screen 100 a desired print pattern among 103a-103d, the “ABC” character string can be printed on the tape 17 in the desired direction.

Furthermore, when the rotated image extends beyond the feasible range for printing (label width 110), the image that has been rotated is scaled-down for printing so as to fall within the label width 110 that corresponds to data processing selected by the data processing-selecting portion 102, or only the portion of the rotated image that falls within the label width 110 is printed. Thus, an “ABC” character string which constitutes an object image for printing can be appropriately printed onto the tape 17.

Next, a second embodiment of the disclosure will be described with reference to the accompanying drawings. As a “printing apparatus” of the disclosure, a portable label printer 3 will be described.

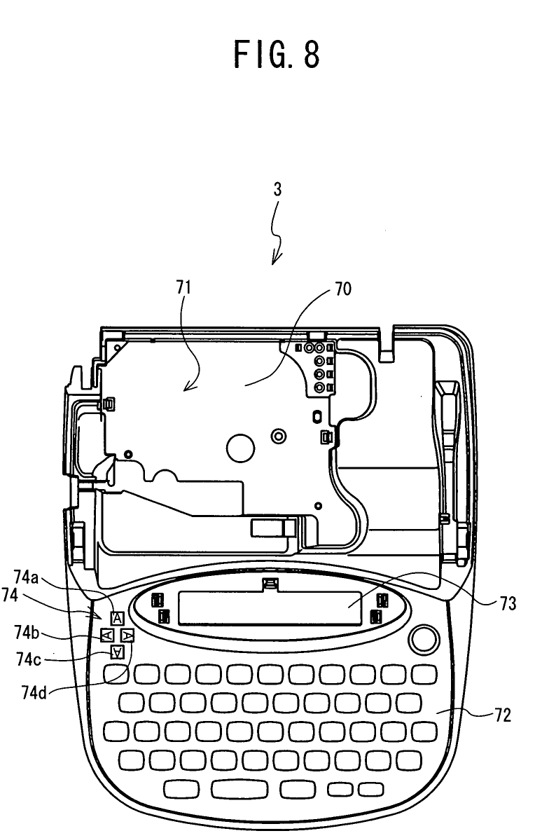

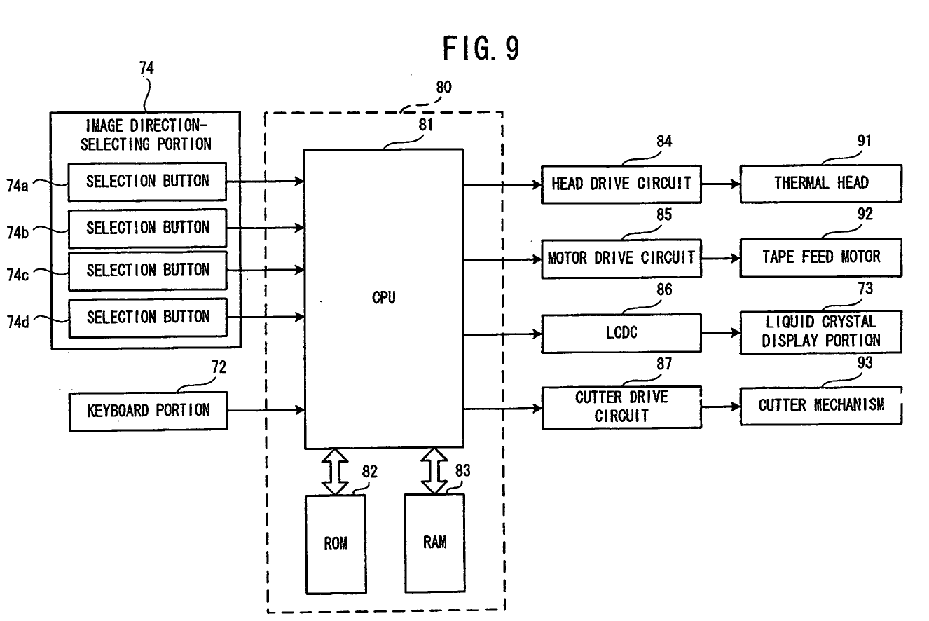

First, the label printer 3 will be described with reference to FIGS. 8 and 9. For ease of understanding, FIG. 8 shows a state in which the lid of a tape-accommodating portion is removed.

As shown in FIG. 8, the label printer 3 is provided with a tape cassette accommodating portion 71, which is a concave portion for accommodating the tape cassette 70 at its rear portion, and, at its front portion, a keyboard portion 72 for use in inputting characters and symbols. The keyboard portion 72 has a plurality of keys for inputting characters, symbols and function commands. A liquid crystal display portion 73 is provided between the tape cassette-accommodating portion 71 and the keyboard portion 72 so that features such as characters and symbols that are input through the keyboard portion 72 can be displayed.

According to this embodiment, an image direction-selecting portion 74 constituted of four buttons disposed in a substantially cross shape is provided on the keyboard portion 72 on the left side of the liquid crystal display portion 73. The image direction-selecting portion 74 is used to enable a user to give instructions for the execution of printing by arbitrarily specifying an image direction. States in which a character A (hereinafter referred to as an exemplified image “A”) is rotated so to be directed respectively upwards, leftwards, downwards and rightwards are indicated on the surfaces of the selection buttons 74a, 74b, 74c, 74d. Thus, before printing image data on a tape (not shown), a user can select a desired image direction by confirming the direction of the exemplified image A by means of the respective selection buttons 74a-74d. Further, in order to enable a user to confirm matters visually the exemplified image “A” represented on each selection button 74a-74d indicates the direction of an image that is printed on the tape when each button is selected.

Next, the electrical configuration of the label printer 3 will be described. As shown in FIG. 9, the label printer 3 includes a control unit 80 comprising a CPU 81, a ROM 82 and a RAM 83. The aforementioned keyboard portion 72, the respective selection buttons 74a-74d of the image direction-selecting portion 74, a head drive circuit 84, a motor drive circuit 85, a display controller (hereinafter referred to as an LCDC) 86 and a cutter drive circuit 87 is connected to the CPU 81. The head drive circuit 84 drives a thermal head 91. The motor drive circuit 85 drives a tape feed motor 92. The LCDC 86 has a video RAM (not shown) for outputting display data onto the liquid crystal display portion 73. The cutter drive circuit 87 drives a cutter mechanism 93.

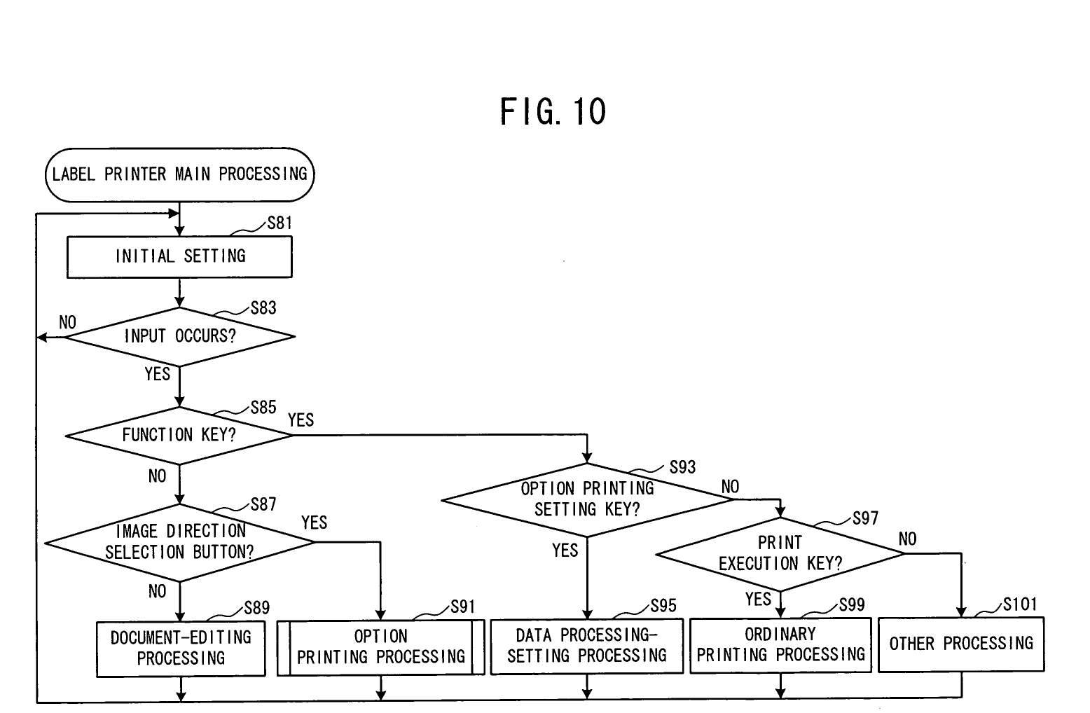

When a the label printer 3 with the structure described above is powered on, main processing (FIG. 10), which will be described later, is executed by the CPU 81 based on the main control program stored in the ROM 82. Further, if instructions are give for the execution of printing after items such as characters are input through the keyboard portion 72, the text (document data) is stored into a text buffer (not shown) of the RAM 83 step by step so that a dot pattern is displayed on the liquid crystal display portion 73 that corresponds to items such as the characters that have been input through the keyboard portion 72. The thermal head 91 is driven through the head drive circuit 84 so as to print dot pattern data (print data) that has been stored in the print buffer (not shown) and synchronously therewith the tape feed motor 92 controls feeding of the tape through the motor drive circuit 85. Finally, when the cutter mechanism 93 cuts out a tape discharged from a tape discharge portion (not shown), a label is produced.

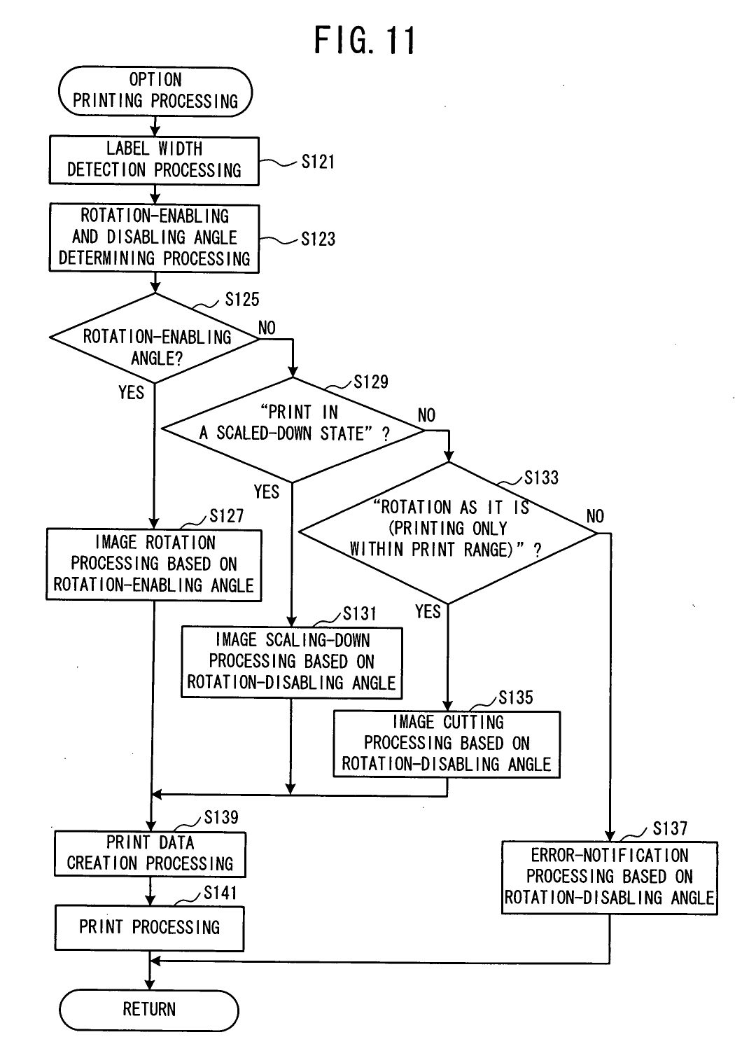

Next, the main processing executed in the label printer 3 will be described with reference to FIGS. 10, 11. The label printer 3 of this embodiment can execute “ordinary printing”, printing of a conventional type which is performed without adjusting the direction of an image, and the “option printing”, printing that is performed with the direction of an image adjusted so as to conform with instructions from a user.

As shown in FIG. 10, in the main processing of the label printer 3, when the label printer 3 has been powered on and started up initialization of factors such as various initial values and flags is first executed (S81). Then, the processing turns into a standby state until any input has been made through the keyboard portion 72 (S83: NO). When the key is input through the keyboard portion 72 (S83: YES), if the key that is input is not a “function key” for setting the function of the label printer 3 (S85: NO), nor one of selection buttons 74a-74d of the image direction-selecting portion 74 enabling a user to specify the direction of the image (S87: NO), that key is a “character key” for use in inputting a character or symbol, and thus, a document-editing processing is executed (S89). In the document-editing processing of S89, a predetermined edition screen is displayed on the liquid crystal display portion 73 and a user can create any document on the document-editing screen using the “character keys”. In this embodiment, it may be assumed that a user inputs an “ABC” character string as an object image for printing by use of the “character key”, and hereinafter, a case will be described in which this “ABC” character string is printed on the tape.

On the other hand, if the input key is a “function key” (S85: YES), the liquid crystal display portion 73 displays a predetermined function-setting screen. In this embodiment, a plurality of function keys such as “option printing setting keys” and “print execution key” as a command menu are displayed on this function-setting screen and a user can select any function key by using the numerical keys or the cursor keys (not shown).

If the “option printing setting key” is selected from the function-setting screen (S93: YES), a data processing-setting processing is executed to enable a user to set arbitrarily data processing that is to be executed when at the time of option printing an object image for printing extends beyond the feasible range for printing (S95). In the data processing-setting processing of S95, a predetermined data processing-setting screen is displayed on the liquid crystal display portion 73 so that a user can arbitrarily select any data processing through the data processing-setting screen. According to this embodiment, three data processings “rotation in a scaled-down state”, “rotation with size maintained” and “rotation as it is (printing only within the printing range)” are displayed as a menu (not shown), and a user can select any data processing by using the numerical keys or the cursor keys (not shown).

When the “print execution key” is selected on the function-setting screen (S93: NO, S97: YES), an ordinary printing processing is executed for printing characters or images that are printed onto the tape (S23). More specifically, an “ABC” character string input by means of the document-editing processing (S89) is stored in a text buffer (not shown) as an object image for printing. Consequently, a dot pattern corresponding to the “ABC” character string stored in the print buffer (not shown) is displayed on the liquid crystal display portion 73 and at the same time, printing of the dot pattern data (print data) and tape feed control are executed synchronously. As a consequence, the “ABC” character string is printed on the tape and finally, the tape is cut out by means of the cutter mechanism 93 so as to create the label.

Further, when another function key is selected from the function-setting screen (S97: NO), another processing that corresponds to that function key is executed (S101). After each processing in S89, S95, S99, S101 and S91 has been executed, the processing returns to S83 in which the apparatus stands by for the next input.

If a key input through the keyboard portion 72 is any one of the selection buttons 74a-74d (S87: YES), an option printing processing is executed with the direction of the image adjusted so as to conform to instructions from a user (S91). The option printing processing (S91) will now be described.

As shown in FIG. 11, in the option printing processing (S91), label width-detecting processing is executed for detecting the width of a label to be set on the tape that constitutes a recording object (S121). According to this label width-detecting processing a label width can be detected from a detection switch (not shown) which detects the tape cassette 70 mounted on the label printer 3.

A determination is made as to whether or not a rotational angle corresponding to one of the selection buttons 74a-74d selected by a user is an angle at which the object image for printing can be rotated (S123). In this embodiment, the selection buttons 74a-74d indicate printing of an object image for printing by rotating for respectively 0°, 90°, 180° and 270° with the exemplified images “A” respectively facing upwards, leftwards, downwards, and rightwards. Thus, if an object image for printing is rotated based on an angle corresponding to any of the selection buttons 74a-74d that has been selected arbitrarily by a user, a determination is made as to whether or not that rotated image does not extend beyond the feasible range for printing (the label width detected in S121) (in other words, whether it is at a rotation-enabling angle).

If it is determined that the rotated image is at a rotation-enabling angle (S125: YES), an image rotation processing is executed for rotating the object image for printing based on that rotation-enabling angle (S127). In this context, when the selection button 74a or 74c is selected, it is determined that the rotated image is at a rotation-enabling angle in S125. Then, like the first embodiment (S47, S55, S61 in FIG. 5), the “ABC” character string, which is an object image for printing, is rotated at 0° or 180° so as to conform to user's selection. Then, in an image rotated for 00, the “ABC” character string is kept as it is (facing upwards) and an image rotated for 180° assumes a downward direction.

On the other hand, if it is determined that an image that has been rotated is not at a rotation-enabling angle (in other words, determined that it is the rotation-disabling angle) and the data processing set in the data processing-setting processing (S95) is “print in a scaled-down state” (S125: NO, S129: YES), an image scaling-down processing is executed for rotating the object image for printing based on that rotation-disabling angle and further scaling-down the rotated image (S131). In this context, if a selection button 74b or 74d is selected, it is determined in S125 that the rotated image is at a rotation-disabling angle. Because the data processing is “print in a scaled-down state”, the “ABC” character string which constitutes an object image for printing is rotated for 90° or for 270° so as to conform with the selection of a user as inthe first embodiment (S49 in FIG. 5), and in an image rotated for 90°, the “ABC” character string is directed to the left and in an image rotated for 270°, the “ABC” character string is directed to the right. Moreover, the entirety of the rotated image of the “ABC” character string is scaled down uniformly so that it can fall within the label width of the tape.

Further, if the data processing set in the data processing-setting processing (S95) is “rotation as it is (printing only within the printing range) (S129: NO, S133: YES), the object image for printing is rotated based on the rotation-disabling angle and a cutting processing of cutting an image so that only a portion that falls within the label width of the rotated image is displayed is executed (S135). Here, like the first embodiment (S63 in FIG. 5), the “ABC” character string, which is an object image for printing is rotated by 90° or 270° so as to conform to the selection of a user and only a portion included within the label width of the rotated image of the “ABC” character string is cut out.

If the data processing set in the data processing-setting processing (S95) is “rotation with size maintained” (S133: NO) a rotational angle corresponding to the one of the selection buttons 74a-74d that has been selected by a user is a rotation-disabling angle, and an error-notification processing of notifying that print based on the rotational angle is not executed is executed (S137). In this error-notification processing, a predetermined print error is displayed on the liquid crystal display portion 73 and an alarm sound is produced from a speaker (not shown). After that, the option printing processing (FIG. 11) is terminated and the processing returns to the main processing (FIG. 10).

After S127, S131, S135 have been executed, the rotated image created in the course of each processing is stored in a predetermined memory area of the RAM 83. Moreover, a print data creation processing is executed for creating print data based on image data (S139). In this context, as in the first embodiment (S13 in FIG. 3), print data for use in printing in the label printer 3 is created from among the rotated images respectively stored in the RAM 83 based on any one of the selection buttons 74a-74d that has been selected arbitrarily and from data processing that has been set in S95. More specifically, if any one of the selection buttons 74a-74d is selected, any corresponding image rotated for 0°, 90°, 180°, 270° is processed based on data processing “rotation in a scaled-down state” or “rotation as it is” (printing only within the printing range) so as to produce print data.

Finally, a print processing is executed for printing a rotated image on the tape based on print data created in S139 so as to produce a label (S141). More specifically, printing of the “ABC” character string and tape feed control are executed synchronously based on print data stored in the print buffer so that the “ABC” character string is printed in a direction of an image set by a user within the label width set on the tape. Finally, the cutter mechanism 93 cuts out the tape that has been discharged from the label discharge port so as to produce a label.

The “ABC” character string is printed on a produced label that has been produced in such a way, in the direction of an image set by a user. Thus, for example, if a user wants to affix a label onto an object with its character string “ABC” facing leftwards, and if the user selects from the image direction-selecting portion 74 the selection button 74b corresponding to the image, the “ABC” character string is printed in such a way that it is facing leftwards, as indicated by the preview image. Therefore, if a user affixes a label that has been discharged from the label discharge port of the label printer 3 on the object as it is, even if the user does not perform any operation of rotating in a circumferential direction and thereby adjusting the affixing direction the “ABC” character string printed on the label on the object is represented in such a way that it is facing leftwards, in the same way as indicated by the exemplified image “A” on the selection button 74b.

The label printer 3 of the second embodiment includes the image direction-selecting portion 74 which indicates each state in which the exemplified image “A” may have been rotated in each of plural directions and produces print data based on a rotated image that corresponds to the one of the selection buttons 74a-74d selected. Moreover, the rotated image is printed within the label width set on the tape based on this print data, and the tape discharged from the label discharge port is cut out so as to produce a label.

Thus, a direction of an object image for printing (an “ABC” character string) that is printed onto the tape can be adjusted appropriately and easily by a user. Moreover, a label can be affixed easily and rapidly onto an object in an affixing direction that is desired for a user, without any need for the user to adjust the affixing direction of the label on each occasion. Further, because a user can select from the image direction-selecting portion 74 the one of the selection buttons 74a-74d desired, the “ABC” character string can be printed on the tape in a direction that is desired by a user.

As described above, in the printing apparatus of the disclosure, if a direction of an image is set relative to a recording object medium, an image rotated so as to conform to the direction of the image is printed onto the recording object medium. Consequently, a user can adjust easily and appropriately the direction of an image that is to be printed so as to conform to the recording object medium.

Further, on the printing apparatus of the disclosure a print setting screen is displayed for displaying plural print patterns that indicate states in which the image may have been rotated in each of plural directions relative to the recording object medium, and prints the image onto the recording object medium based on a print pattern selected from this print setting screen. Thus, because a user can select from the print setting screen a desired print pattern, the user can print the image onto the recording object medium in a direction that is favored by the user.

The printing apparatus of the disclosure includes a plurality of image direction selection buttons indicating states in which an exemplified image may have been rotated in each of plural directions relative to the recording object medium and prints onto the recording object medium an image that has been rotated and that corresponds to any one of these image direction selection buttons that has been selected. Consequently, because a user can select from the plural image direction selection buttons a button on which the exemplified image of the user is indicated, the user can print the image onto the recording object medium in a direction that is favored by the user.

Furthermore, in the printing apparatus of the disclosure, if an image extends beyond a feasible range for printing onto the recording object medium, the image is printed in a scaled-down state in such a way that in its scaled-down form the image will fall within the print feasible range for printing, and can be appropriately printed onto the recording object medium.

In the printing apparatus of the disclosure, if an image extends beyond a feasible range for printing on the recording object medium, only the portion of the image that falls within the feasible range for printing is printed. Consequently, because partial printing is carried out if the image extends beyond the feasible range for printing, the image can be printed onto the recording object medium appropriately.

If in the printing apparatus of the disclosure an image extends beyond the feasible range for printing onto the recording object medium, a notification thereof is made as a print error. Consequently, because error notification is performed when the image extends beyond the feasible range for printing, the image can be printed onto the recording object medium appropriately.

In the printing apparatus of the disclosure, the recording object medium is a long tape and a recording object medium on which printing has taken place is cut out at a portion onto which it can be discharged so as to produce a label. Consequently, if the disclosure is implemented as a tape printing apparatus, the label can be easily and rapidly affixed onto an object in a direction that is favored by a user without the need for a user to adjust the affixing direction of the label on each occasion.

The control program for the printing apparatus of the disclosure includes a print control step. According to this step, the direction of an image relative to the recording object medium has been set in an image direction-setting step, an image that has been rotated is printed onto the recording object medium so as to conform to the direction of that image. Consequently, the direction of an image that is printed onto the recording object medium can be adjusted easily and appropriately by a user.

Further, in the control program for the printing apparatus of the disclosure, a print setting screen is displayed in the print setting screen creation step, and in a displaying step plural print patterns are displayed indicating states in which an image may have been rotated in each of plural directions relative to the recording object medium, and the image is printed onto the recording object medium based on a print pattern selected from this print setting screen. Consequently, because a user can select from the print setting screen a desired print pattern, the user can print the image onto the recording object medium in a direction that is desired by the user.

The control program for the printing apparatus of the disclosure includes a print control step in which plural image direction selection buttons are provided indicating states in which an exemplified image may have been rotated in each of plural directions relative to the recording object medium, and in which an image that has been rotated corresponding to any one of these image direction selection buttons that has been selected is printed onto the recording object medium. Consequently, because a user can select from among the plural image direction selection buttons a button indicating a desired exemplified image, the user can print onto the recording object medium an image in a direction that is favored by the user.

The control program for the printing apparatus of the disclosure includes a print control step, according to which, when an image extends beyond the feasible range for printing on the recording object medium, the image is printed in a scaled down state in such a way that that in its scaled-down state the image will fall within the feasible range for printing on the recording object medium. Consequently, because printing in a scaled-down state is carried out when the image extends beyond the feasible range for printing, the image can be printed appropriately onto the recording object medium.

The control program for the printing apparatus of the disclosure includes a print control step, according to which, when an image extends beyond the feasible range for printing on the recording object medium, only the portion of the image that falls within the feasible range for printing. Consequently, because partial printing is carried out when the image extends beyond the feasible range for printing, the image can be printed appropriately onto the recording object medium.

The control program for the printing apparatus of the disclosure includes notifying step, according to which, when the image extends beyond the feasible range for printing on the recording object medium, a notification thereof is made as a print error. Consequently, because error is notified when the image extends beyond the feasible range for printing, the image can be printed appropriately onto the recording object medium.

In the control program for the printing apparatus of the disclosure, the recording object medium is a long tape and a cutting step is provided for cutting a recording object medium on which printing has taken place at a portion onto which it can be discharged so as to produce a label. Consequently, if the disclosure is implemented as a tape printing apparatus, a user can affix the label onto an object easily and rapidly in an affixing that is favored by the user, without the need of adjusting the affixing direction of the label on each occasion.

The disclosure is not restricted to the above-described embodiments described above and, needless to say, may be modified in various ways. For example, although the embodiments described above exemplify cases where the direction of the image to be printed onto the recording object medium can be selected from among four directions, upwards, downwards, rightwards and leftwards, the direction of the image, and the quantity of directions thereof, may be set arbitrarily. For example, it is also permissible to use the printing apparatus of the disclosure in such a way that any direction from among a total of eight directions can be selected as the direction of the image including, in addition to upwards, downwards, rightwards, and leftwards, upwards in a rightward direction, upwards in a leftward direction, downwards in a rightward direction and downwards in a leftward direction. In such circumstances, the print patterns displayed on the option printing screen 100 and the selection buttons provided on the image direction-selecting portion 74 may be set so as to cover eight directions.

The exemplified images indicated on the selection buttons 74a-74d on the image direction-selecting portion 74 need not be restricted to “A”, but a variety of characters or graphics may be used that enables a user to recognize the direction of an image. For example, as exemplified images indicated on the selection buttons 74a-74d, an “XYZ” character string, or an asymmetrical rectangle, may be used.

Further, data processing executed when an image that has been rotated based on an object image for printing extends beyond the feasible range for printing onto the recording object medium need not be restricted to “rotation in a scaled-down state”, “rotation with size maintained” and “rotation as it is (printing only within the printing range)” but may be set arbitrarily. For example, an image that has been rotated based on an object image for printing may be divided up so as to be printed onto plural labels or only a direction in which the image extends beyond the feasible range for printing may be scaled down.

Cases in which the disclosure is applied to a printer (tape printing apparatus 1 and label printer 3) and which produce a label have been exemplified above. However, the disclosure can also be applied to a variety of printing apparatuses regardless of the kind of recording object medium, and regardless of the type of printing including the thermal type and the ink jet type.

The printing apparatus of the disclosure can also be used as a printing apparatus that is capable of adjusting the direction of an image that is to be printed onto the recording object medium.

In the illustrated embodiment, the controller preferably is implemented using a suitably programmed general purpose computer, e.g., a microprocessor, microcontroller or other processor device (CPU or MPU). It will be appreciated by those skilled in the art, that the controller also can be implemented as a single special purpose integrated circuit (e.g., ASIC) having a main or central processor section for overall, system-level control, and separate sections dedicated to performing various different specific computations, functions and other processes under control of the central processor section. The controller also can be implemented using a plurality of separate dedicated or programmable integrated or other electronic circuits or devices (e.g., hardwired electronic or logic circuits such as discrete element circuits, or programmable logic devices such as PLDs, PLAs, PALs or the like). The controller also can be implemented using a suitably programmed general purpose computer in conjunction with one or more peripheral (e.g., integrated circuit) data and signal processing devices. In general, any device or assembly of devices on which a finite state machine capable of implementing the described procedures can be used as the controller of the disclosure.

What is claimed is:

1. A printing apparatus comprising:
a printing device that prints onto a recording object medium an image based on print data;
an image direction-setting device that arbitrarily sets a direction of the image relative to the recording object medium;
an image-rotating device that rotates the image; and
a print control device that enables the printing device to print the image rotated by the image-rotating device so as to conform to the direction of the image set by the image direction-setting device.

2. The printing apparatus according to claim 1 wherein, the image-rotating device creates a plurality of print patterns indicating states in which the image has been rotated in plural directions relative to the recording object medium, the printing apparatus further comprising:
a print setting screen-creating device that creates a print setting screen on which the plural print patterns are displayed in such a way that they can be selected; and
a display device that displays the print setting screen,
the image direction-setting device selects an arbitrary print pattern from the print setting screen displayed on the display device, and
the print control device enables the printing device to print the image based on the selected print pattern.

3. The printing apparatus according to claim 1 wherein, the image direction-setting device is plural image direction-selecting buttons indicating states in which an exemplified image is rotated in plural directions relative to the recording object medium,
the image-rotating device rotates the image based on a rotational state so as to be conform to any one of the plural image direction-selecting buttons selected,
the print control device enables the printing device to print the image rotated so as to conform to any one of the plural image direction-selecting buttons.

4. The printing apparatus according to claim 1 wherein, when the image is printed onto a recording object medium, if the image extends beyond a feasible range for printing onto the recording object medium, the print control device enables the image to be printed in a scaled-down state so that it becomes capable of falling within the feasible range for printing on the recording object medium.

5. The printing apparatus according to claim 1 wherein, when the image is printed onto a recording object medium, if a print range of the image extends beyond a feasible range for printing on the recording object medium, the print control device enables printing of only a portion that falls within the feasible range for printing on the recording object medium.

6. The printing apparatus according to claim 1 further comprising a notification device that, when the image is printed onto the recording object medium, if a print range of the image extends beyond a feasible range for printing on the recording object medium, makes a notification to that effect as a print error.

7. The printing apparatus according to claim 1 wherein the recording object medium is a long tape comprised of a printing medium on which the image is printed, an adhesive agent layer provided on a rear surface of the printing medium and a separation layer that covers the adhesive agent layer, the printing apparatus further comprising a cutting device that cuts the recording object medium so as to produce a label at a portion onto which the recording object medium on which the image is printed is discharged.

8. A printing apparatus comprising:
a printing device that prints onto a recording object medium an image based on print data; and
a control device that arbitrarily sets a direction of the image relative to the recording object medium, rotates the image and enables the printing device to print the rotated image so as to conform to the direction of the image that has been set.

9. The printing apparatus according to claim 8 further comprising a display device that displays various items of information, wherein the control device creates a plurality of print patterns indicating states in which the image has been rotated in plural directions relative to the recording object medium, creates a print setting screen in which the plural print patterns are displayed in such a way that they can be selected, selects an arbitrary print pattern from the print setting screen displayed on the display device, displays the selected print pattern on the display device and enables the printing device to print the image based on the selected print pattern.

10. The printing apparatus according to claim 8 wherein the control device rotates the image based on a rotational state corresponding to any one of plural exemplified images selected arbitrary, in a state of having been rotated in plural directions relative to the recording object medium, and enables the printing device to print the rotated image.

11. The printing apparatus according to claim 8 wherein, when the image is printed onto a recording object medium, if the image extends beyond a feasible range for printing onto the recording object medium, the control device enables the image to be printed in a scaled-down state so that it becomes capable of falling within the feasible range for printing on the recording object medium.

12. The printing apparatus according to claim 8 wherein, when the image is printed onto a recording object medium, if a feasible range for printing of the image extends beyond a feasible range for printing on the recording object medium, the control device enables printing of only a portion that falls within the feasible range for printing on the recording object medium.

13. The printing apparatus according to claim 8 further comprising a notification device that, when the image is printed onto the recording object medium, if a range for printing of the image extends beyond a feasible range for printing on the recording object medium, makes a notification to that effect as a print error.

14. The printing apparatus according to claim 8 wherein the recording object medium is a long tape comprised of a printing medium on which the image is printed, an adhesive agent layer provided on a rear surface of the printing medium and a separation layer that covers the adhesive agent layer, the printing apparatus further comprising a cutting device that cuts the recording object medium so as to produce a label at a portion onto which the recording object medium on which the image is printed is discharged

15. A control program for a printing apparatus recorded on a computer-readable recording medium, comprising:
an image direction-setting step of setting arbitrarily a direction of an image relative to a recording object medium;
an image-rotating step of rotating the image; and
a print control step of printing the image rotated in the image-rotating step so as to conform to the direction of the image set in the image direction-setting step.

16. The control program for a printing apparatus according to claim 15 further comprising:
a print setting screen-creating step of creating a print setting screen that can display plural print patterns created in the image-rotating step and that indicate states in which the image has been rotated in plural directions relative to the recording object medium, so that the plural print patterns are selectable; and
a displaying step of displaying the print setting screen, wherein
in the image direction-setting step, any print pattern can be selected from the print setting screen displayed in the displaying step and
in the print control step, the image based on a print pattern selected in the image direction-setting step is printed.

17. The control program for a printing apparatus according to claim 15 wherein
in the image-rotating step, the image is rotated based on a rotational state corresponding to any one of plural predetermined rotational states selected, and that is relative to the recording object medium, and
in the print control step, the image that has been rotated, and that corresponds to one of the plural predetermined rotational states, is printed.

18. The control program for a printing apparatus according to claim 15 wherein
in the print control step, when the image is printed onto the recording object medium, the image is printed in a scaled-down state so that, when the image extends beyond a feasible range for printing on the recording object medium, the scaled-down image becomes capable of falling within the feasible range for printing on the recording object medium.

19. The control program for a printing apparatus according to claim 15 wherein in the print control step, when the image is printed onto the recording object medium, at times when a print range of the image extends beyond a feasible range for printing on the recording object medium, only a portion of the image that falls within the feasible range for printing on the recording object medium is printed.

20. The control program for a printing apparatus according to claim 15 further comprising a notification step of notifying that, when the image is printed onto the recording object medium in the print control step, if a print range of the image extends beyond a feasible range for printing on the recording object medium, makes a notification to that effect as a print error.

21. The control program for a printing apparatus according to claim 15 further comprising a cutting step of cutting the recording object medium so as to produce a label at a portion onto which the recording object medium on which the image is printed in the print control step is discharged.
